(19) United States
(12) Patent Application Publication
(10) Pub. No.: US 2013/0111749 A1
(43) Pub. Date: May 9, 2013

(54) METHOD FOR FABRICATING A CONDUCTING TERMINAL SET FOR ELECTRICAL CONNECTOR

(71) Applicant: RIIDEA INTERNATIONAL CORP., Apia (WS)

(72) Inventor: Lung-Hsi LEE, New Taipei City (TW)

(73) Assignee: RIIDEA INTERNATIONAL CORP., Apia (WS)

(21) Appl. No.: 13/669,095

(22) Filed: Nov. 5, 2012

(30) Foreign Application Priority Data
Nov. 9, 2011 (TW) 100140941

(51) Int. Cl. H01R 43/16

(52) U.S. Cl. 29/885

(57) ABSTRACT

A method for fabricating a conducting terminal set for electrical connector by: employing a cold drawing technique to repeatedly draw a metal round rod into a predetermined flat elliptical conducting terminal bar and to cut the flat elliptical conducting terminal bar into flat elliptical conducting terminals, and then preparing a terminal bracket and then positioning the flat elliptical conducting terminals in the terminal bracket in a parallel manner, and then coating the flat elliptical conducting terminals locally, and then bending respective one ends of the flat elliptical conducting terminals backwardly upwards to form respective resilient mating end portions, and then inserting the other ends of the flat elliptical conducting terminals into a terminal block.

This application claims the priority benefit of Taiwan patent application number 100140941, filed on Nov. 09, 2011.

### BACKGROUND OF THE INVENTION

1. Field of the Invention

The present invention relates to a method for fabricating a conducting terminal set and more particularly, to a method for fabricating a conducting terminal set for electrical connector, which employs a cold drawing procedure to draw a metal round rod into a conducting terminal bar, eliminating further secondary punching and cutting procedures and avoiding material loss.

2. Description of the Related Art

Mineral resources are important raw materials and power source of modern industries. The well developed industrial countries have a relatively greater demand for minerals. The consumption of mineral energy in a country is an index to measure the economic development of the country.

The world average energy consumed per person per year can be approximately converted to 2 tons of coal produced energy. The average energy consumed per person per year in USA is about 12 tons, 5-6 tones in Western Europe, 4.5 tons in Japan, or below 0.5 tone in most developing countries.

Further, rich mineral resources can promote the economic development of a country. For example, South Africa is rich in mineral resources, and has become the most developed industrial country in Africa.

However, mineral is a nonrenewable resource. The mining cycle of a mineral is often millions of years. Minerals decrease rapidly with rapid increase in consumption. In consequence, mineral price rises with mineral reduction. The prices of steel, iron, copper and other metal materials increase year after year. In response to the pressure of raw material price surging, manufacturers can only but to modify their manufacturing processes to save the consumption of materials.

Following fast development of computer and communication related technologies, various advanced desk computers, notebooks, tablet computers, smart phones and many other mobile electronic devices have been created. The use of these mobile electronic devices is prevalent across all ages. Many other related peripheral electronic products, such as photo printer, digital video camera, digital camera, and etc. have also been widely used. Many electric connectors have also been created for use in various mobile electronic devices and related peripheral electronic products for signal transmission between a main unit and a peripheral electronic product. An electric connector uses conducting terminals for transmitting data signal and power supply. Keeping the contact faces of the conducting terminals of an electric connector on a plane is quite important to ensure signal transmission reliability. If the contact faces of the conducting terminals are not kept on a plane, noses or signal transmission interruption may occur during operation of the electronic connector. USB connectors, RJ connectors, memory card connectors, card reader connectors and many other types of electric connectors use flat conducting terminals. A flat conducting terminal has a relatively larger contact surface area to ensure signal transmission stability. FIG. 12 illustrates a conducting terminal bar made of a metal sheet material A using a stamping technique. During fabrication, undesired part A2 is cut off from the metal sheet material A, leaving a predetermined number of conducting terminals A1 connected in parallel to a material strip A3. This conducting terminal fabrication method has drawbacks as follows:

1. When cutting off undesired part A2 from the metal sheet material A, much material is wasted, increasing the cost. Therefore, this method is not cost effective.

2. When stamping the metal sheet material A into a conducting terminal bar, the conducting terminals A1 may be irregularly curved, affecting further follow-up processing. After insertion of the conducting terminals A1 into a terminal block, the mating end portions of the conducting terminals A1 may be not kept on a plane, affecting signal transmission stability and reliability.

Further, conducting terminals can be directly made of individual metal rod members and then electroplated. Alternatively, metal rod members can be electroplated and then stamped into shape. According to conventional conducting terminal fabrication methods, the whole surface area of each conducting terminal is electroplated. However, it is a waste to electroplate the unnecessary surface area of each conducting terminal.

Therefore, it is desirable to provide a conducting terminal fabrication method, which avoids material loss and saves the manufacturing cost of conducting terminals.

### SUMMARY OF THE INVENTION

The present invention has been accomplished under the circumstances in view. It is therefore the main object of the present invention to provide a method for fabricating a conducting terminal set for electrical connector, which avoids material loss, saves conducting terminal manufacturing cost, and improves conducting terminal signal transmission reliability.

To achieve this and other objects of the present invention, a method for fabricating a conducting terminal set for electrical connector comprises the step of employing a cold drawing technique to repeatedly draw a metal round rod into a predetermined round or flat elliptical conducting terminal bar by means of a plurality of cold drawing dies that have a different size of cold drawing hole, the step of cutting the flat elliptical conducting terminal bar into multiple pieces of flat elliptical conducting terminals subject to a predetermined length, the step of preparing a terminal bracket having a plurality of clamping grooves using a stamping technique and then positioning the flat elliptical conducting terminals in the clamping grooves of the terminal bracket in a parallel manner, the step of employing a coating technique to locally coat the flat elliptical conducting terminals with a coating, and the step of bending respective one ends of the flat elliptical conducting terminals backwardly upwards to form respective resilient mating end portions.

Further, in an embodiment, the predetermined flat elliptical conducting terminal bar thus obtained has two opposing flat surfaces and two opposing smoothly curved edges.

Further, coating the flat elliptical conducting terminals is to employ one of the coating techniques of electroplating, brushing plating and hot-dip plating to coat a predetermined part of the flat elliptical conducting terminals with a coating.

The method for fabricating a conducting terminal set for electrical connector further comprises the step of inserting respective opposite ends of the flat elliptical conducting terminals at an opposite side of the terminal bracket through respective terminal slots of an electrically insulative terminal block, and the step of cutting off the respective opposite ends of the flat elliptical conducting terminals subject to a predetermined length and removing the terminal bracket from the flat elliptical conducting terminals, thereby forming respective bonding end portions.

In an alternate form of the present invention, prepared flat elliptical conducting terminals are positioning in two terminal brackets and then locally coated, and then respective one ends of the two sets of flat elliptical conducting terminals are inserted through two vertically spaced staggered rows of terminal slots, of an electrically insulative terminal block, and then the respective one ends of the flat elliptical conducting terminals are bent into respective mating end portions, and then respective opposite ends of the flat elliptical conducting terminals are cut subject to a predetermined length to form respective bonding end portions.

### BRIEF DESCRIPTION OF THE DRAWINGS

FIG. 1 is a schematic drawing illustrating a metal round rod drawn into a flat elliptical conducting terminal bar in accordance with the present invention.

FIG. 2 is a flow chart of a conducting terminal set fabricating method in accordance with a first embodiment of the present invention.

FIG. 3 illustrates a set of flat elliptical conducting terminals and a terminal bracket prepared according to the first embodiment of the present invention before positioning.

FIG. 4 corresponds to FIG. 3, illustrating the prepared flat elliptical conducting terminals positioned in the terminal bracket and bent into shape according to the first embodiment of the present invention.

FIG. 5 is a flow chart of a conducting terminal set fabricating method in accordance with a second embodiment of the present invention.

FIG. 6 illustrates a set of flat elliptical conducting terminals fastened to a terminal bracket prepared according to the second embodiment of the second embodiment of the present invention before positioning installation in an electrically insulative terminal block.

FIG. 7 corresponds to FIG. 6, illustrating the flat elliptical conducting terminals fastened to the electrically insulative terminal block.

FIG. 8 illustrates a set of flat elliptical conducting terminals and a terminal bracket prepared according to a third embodiment of the present invention before positioning.

FIG. 9 illustrates two sets of flat elliptical conducting terminals respectively positioned in respective terminal brackets before installation in an electrically insulative terminal block according to the third embodiment of the present invention.

FIG. 10 corresponds to FIG. 9, illustrating the two sets of flat elliptical conducting terminals fastened to respective rows of terminal slots of an electrically insulative terminal block and bent into shape.

FIG. 11 corresponds to FIG. 10, illustrating the two sets of flat elliptical conducting terminals bonded to a circuit board before installation in an electrically insulative housing.

FIG. 12 is an oblique elevation of a terminal bar prepared according to the prior art.

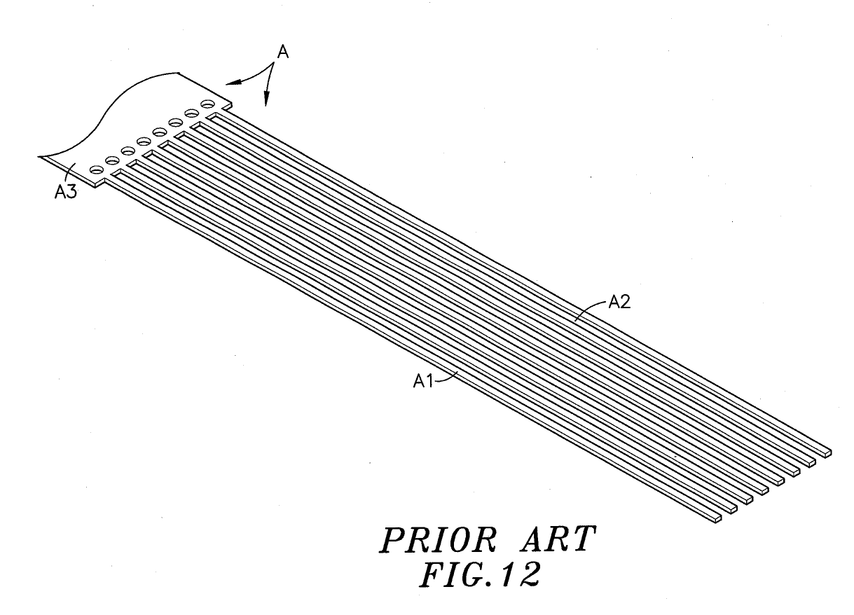

### DETAILED DESCRIPTION OF THE PREFERRED EMBODIMENT

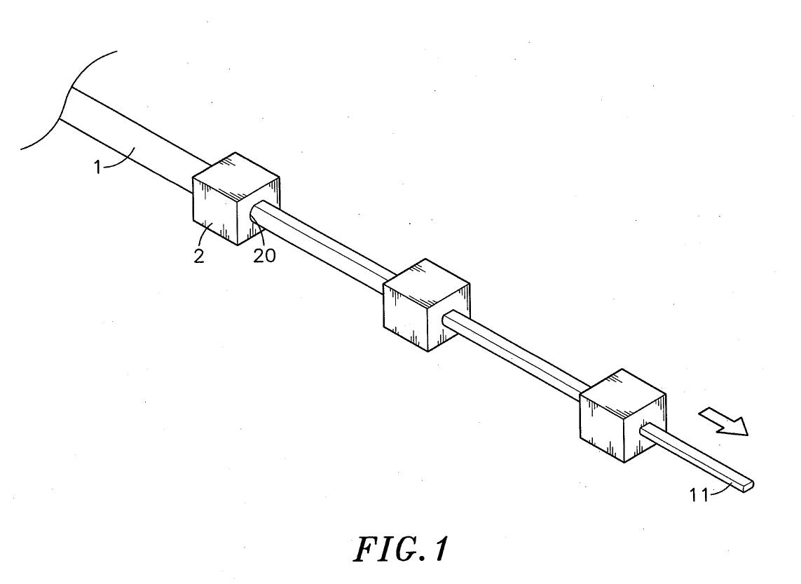

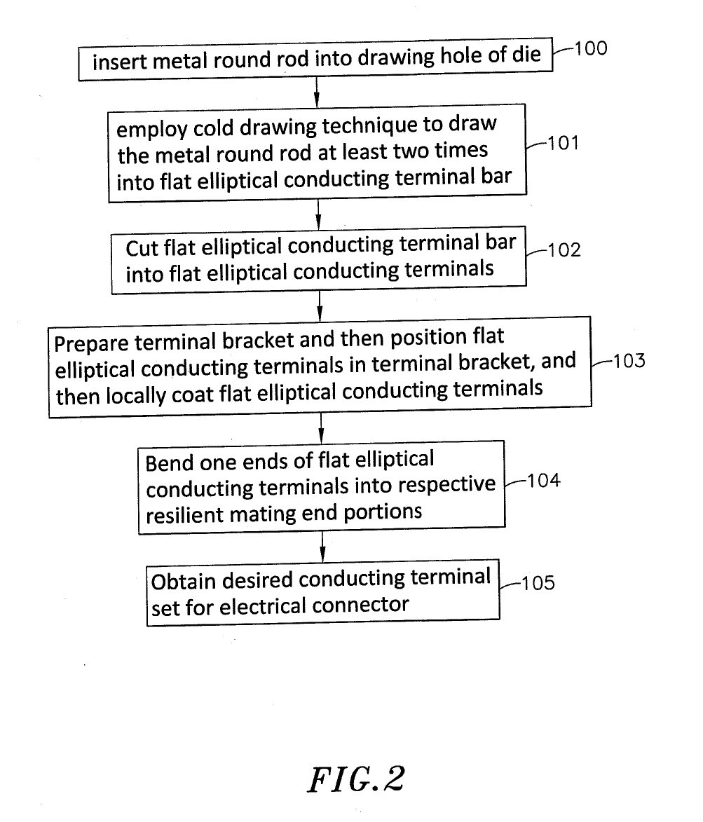

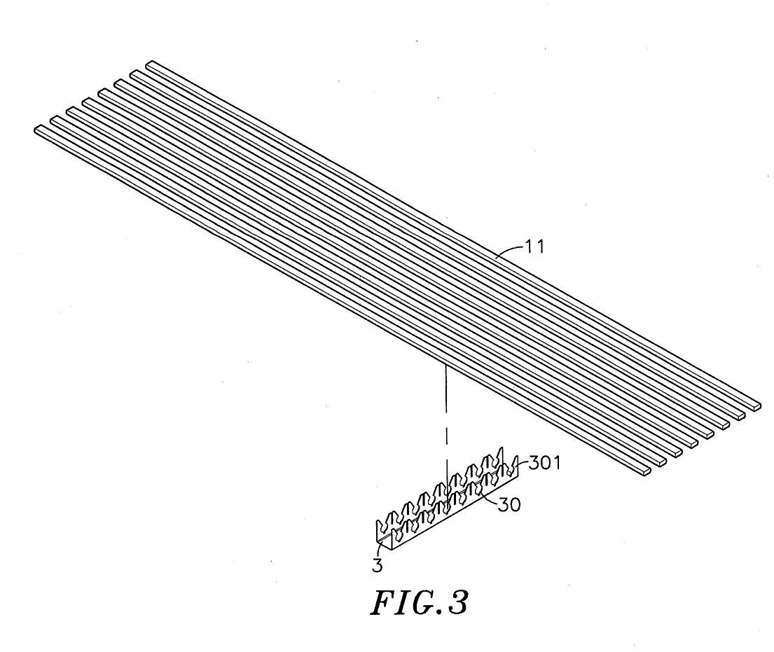

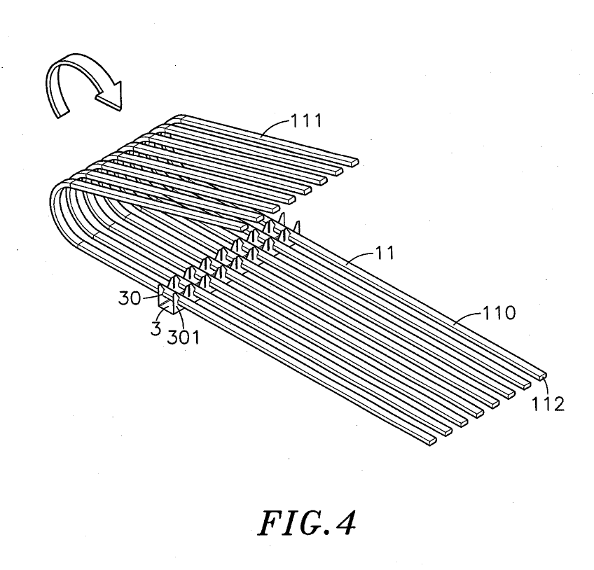

Referring to FIGS. 1-4, a method for fabricating a conducting terminal set for electrical connector in accordance with a first embodiment of the present invention is shown comprising the steps of:

(100) inserting a metal round rod 1 into a drawing hole 20 of a die 2;

(101) employing a cold drawing technique to draw the metal round rod 1 at least two times to have the metal round rod 1 be drawn into a predetermined flat elliptical conducting terminal bar;

(102) cutting the flat elliptical conducting terminal bar thus obtained into pieces of flat elliptical conducting terminals 11 subject to a predetermined length;

(103) preparing a terminal bracket 3 using a stamping technique, and then positioning a predetermined number of flat elliptical conducting terminals 11 thus obtained in clamping grooves 30 of the terminal bracket 3 in a parallel manner, and then locally coating the flat elliptical conducting terminals 11 with a coating;

(104) bending respective one ends of the flat elliptical conducting terminals 11 at one side of the terminal bracket 3 backwardly upwards to have the respective ends of the flat elliptical conducting terminals 11 be formed into respective resilient mating end portions 111; and

(105) obtaining the desired conducting terminal set for electrical connector.

During the aforesaid conducting terminal set preparation procedure, multiple drawing dies 2 that have a different size of drawing hole 20 are prepared and used for drawing the metal round rod 1 into a relatively thinner bar. The metal round rod 1 is drawn for several times. In each cold drawing, the size of the metal round rod 1 is reduced and the metal round rod 1 is turned into a smaller size metal round rod 1. In the final cold drawing step, the small metal round rod 1 is drawn into a predetermined flat elliptical conducting terminal bar. Unlike a conventional conducting terminal fabrication method using a stamping technique that produces waste material, the cold drawing procedure of the invention avoids material loss.

Further, the aforesaid terminal bracket 3 is made of a plate member using a stamping technique, having a substantially U-shaped cross section and a plurality of clamping grooves 30 at each of the two opposite upright sidewalls 301.

After preparation of the terminal bracket 3, a predetermined number of flat elliptical conducting terminals 11 are then positioned in the clamping grooves 30 of the terminal bracket 3 in a parallel manner. A coating technique of electroplating can then be employed to cover a predetermined part of each flat elliptical conducting terminal 11 with a coating, such as brushing plating one side or both sides of the flat elliptical conducting terminal 11, or hot-dip plating a predetermined section of the flat elliptical conducting terminal 11, enhancing the surface friction force of the flat elliptical conducting terminals 11 and improving their signal transmission reliability. The terminal bracket 3 can be used to control the part and area of the flat elliptical conducting terminals 11 to be immersed in the electroplating bath. Unlike conventional techniques of electroplating the whole surface of each individual conducting terminal bar prior to the step of positioning the conducting terminals in the terminal bracket, the invention allows the flat elliptical conducting terminals 11 to be partially coated with a coating after positioned in the terminal bracket 3, saving the electroplating cost.

After local coating, respective one ends of the flat elliptical conducting terminals 11 at one side of the terminal bracket 3 are bent backwardly upwards to have the respective ends of the flat elliptical conducting terminals 11 be formed into respective resilient mating end portions 111 that are elastically deformable. The desired conducting terminal set is thus obtained. Thus, the integrity of the flat elliptical conducting terminals 11 can be maintained for further follow-up procedure to make an electrical connector, ensuring signal transmission reliability.

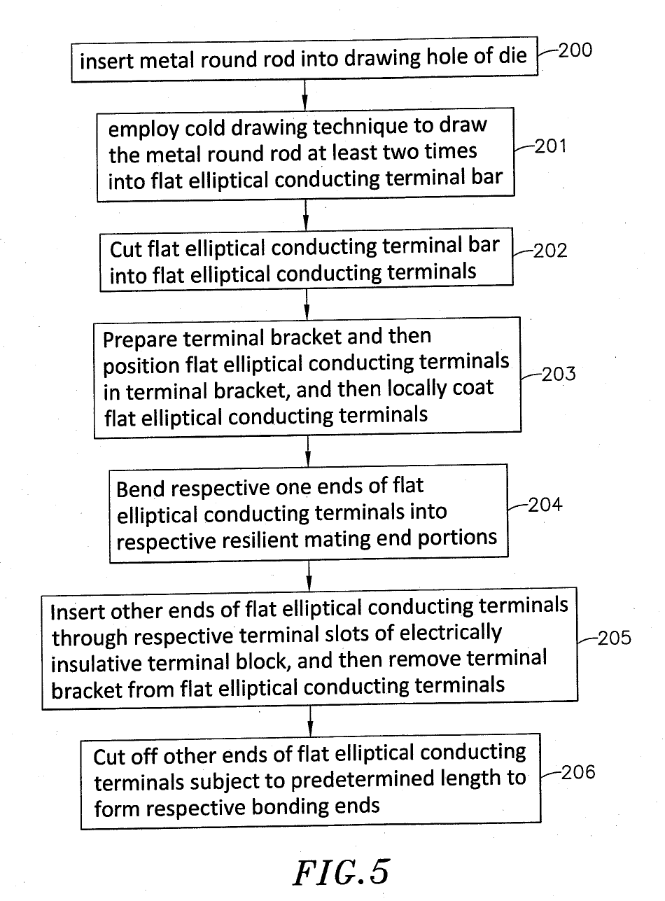

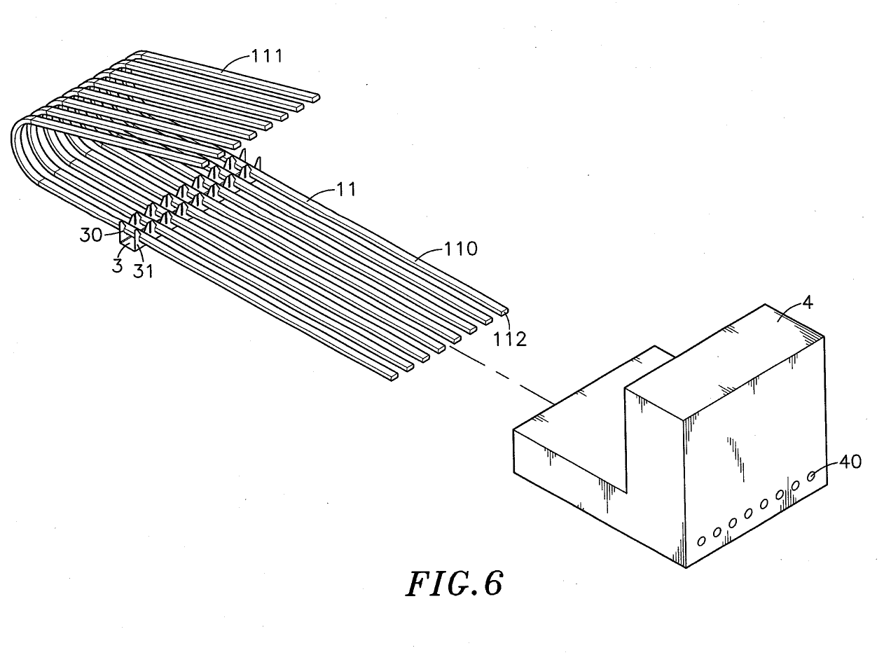

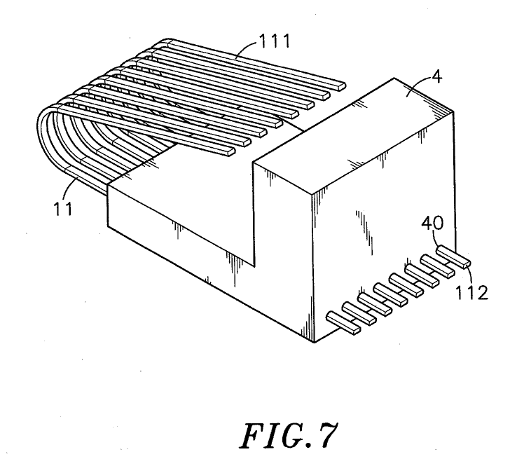

Referring to FIGS. 6 and 7 and FIGS. 1, 4 and 5 again, a method for fabricating a conducting terminal set for electrical connector in accordance with a second embodiment of the present invention is shown comprising the steps of:

(200) inserting a metal round rod 1 into a drawing hole 20 of a die 2;

(201) employing a cold drawing technique to draw the metal round rod 1 at least two times to have the metal round rod 1 be drawn into a predetermined flat elliptical conducting terminal bar;

(202) cutting the flat elliptical conducting terminal bar thus obtained into pieces of flat elliptical conducting terminals 11 subject to a predetermined length;

(203) preparing a terminal bracket 3 using a stamping technique, and then positioning a predetermined number of flat elliptical conducting terminals 11 thus obtained in clamping grooves 30 of the terminal bracket 1 in a parallel manner, and then locally coating the flat elliptical conducting terminals 11 with a coating;

(204) bending respective one ends of the flat elliptical conducting terminals 11 at one side of the terminal bracket 3 backwardly upwards to have the respective ends of the flat elliptical conducting terminals 11 be formed into respective resilient mating end portions 111; and

(205) inserting the other ends 110 of the flat elliptical conducting terminals 11 at the other side of the terminal bracket 3 through respective terminal slots 40 of an electrically insulative terminal block 4; and

(206) cutting off the other ends 110 of the flat elliptical conducting terminals 11 that protrude over a back side of the terminal block 4 to have a predetermined length of the protruding part of the other end 110 of each of the flat elliptical conducting terminals 11 form a respective bonding end portion 112.

During the aforesaid conducting terminal set preparation procedure, multiple drawing dies 2 that have a different size of drawing hole 20 are prepared and used for drawing the metal round rod 1 into a relatively thinner bar. The metal round rod 1 is drawn for several times. In each cold drawing, the size of the metal round rod 1 is reduced and the metal round rod 1 is turned into a smaller size metal round rod 1. In the final cold drawing, a small round conducting terminal bar is obtained. In another embodiment, the small round conducting terminal bar is further drawn into a predetermined flat elliptical conducting terminal bar having two opposing flat surfaces and two opposing smoothly curved edges. The flat elliptical conducting terminal bar is then cut into pieces of flat elliptical conducting terminals 11 subject to a predetermined length. By means of employing the aforesaid cold drawing technique instead of a complicated heavy machining procedure, the invention has the advantages of low risk, fast processing speed, simple processing steps, cost saving and elimination of need for secondary processing.

After the flat elliptical conducting terminals 11, the terminal bracket 3 and the electrically insulative terminal block 4 are assembled together, the conducting terminal set thus obtained can be used for making an electrical connector, such as RJ-11 connector, RJ-45 connector, memory card connector, card reader connector, USB connector, and etc.

After preparation of the terminal bracket 3, a predetermined number of flat elliptical conducting terminals 11 are then positioned in the clamping grooves 30 of the terminal bracket 3 in a parallel manner. A coating technique of electroplating, can then be employed to cover a predetermined part of each flat elliptical conducting terminal 11 with a coating, such as brushing plating one side or both sides of each flat elliptical conducting terminal 11, or hot-dip plating a predetermined section of the flat elliptical conducting terminal 11, enhancing the surface friction force of the flat elliptical conducting terminals 11 and improving their signal transmission reliability. After local electroplating, respective one ends of the flat elliptical conducting terminals 11 at one side of the terminal bracket 3 are bent backwardly upwards to have the respective ends of the flat elliptical conducting terminal 11 be formed into respective resilient mating end portions 111 that are elastically deformable.

Thereafter, insert the other ends 110 of the flat elliptical conducting terminals 11 at the other side of the terminal bracket 3 through respective terminal slots 40 of the electrically insulative terminal block 4, and then cut off the other ends 110 of the flat elliptical conducting terminals 11 that protrude over the back side of the terminal bracket 3 to have a predetermined length of the protruding part of the other end 110 of each of the flat elliptical conducting terminals 11 form a respective bonding end portion 112. Then, the terminal bracket 3 is removed.

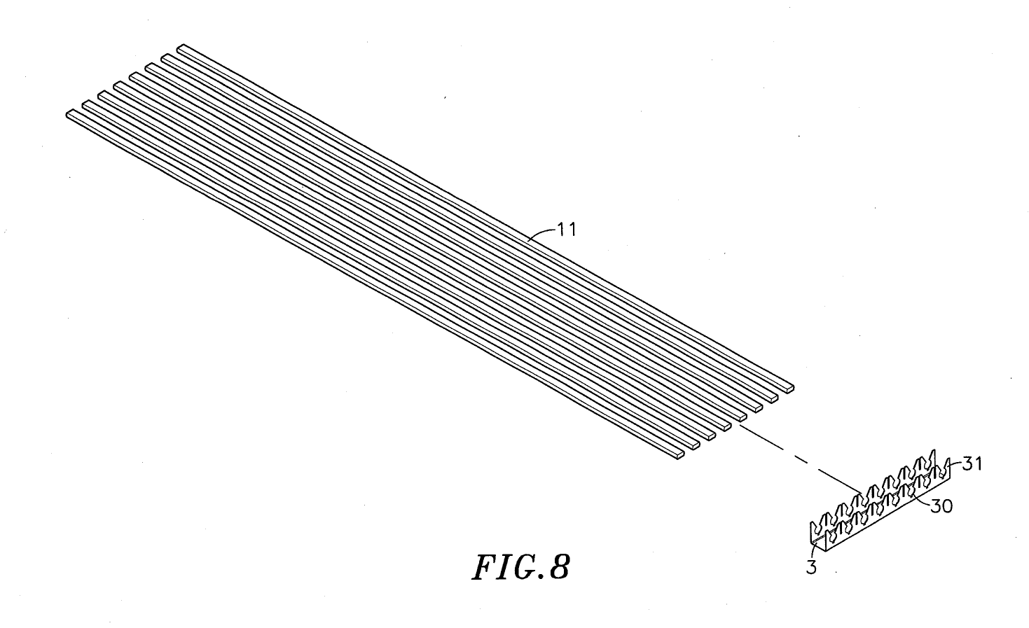

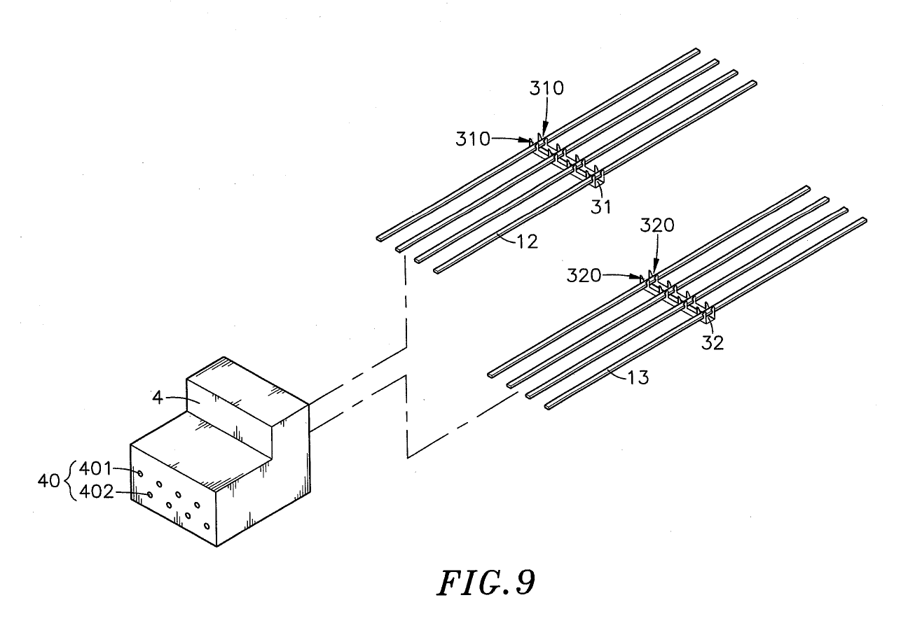

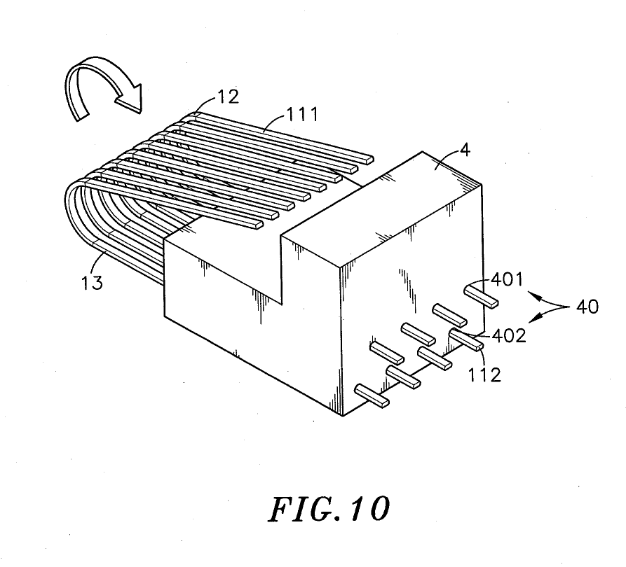

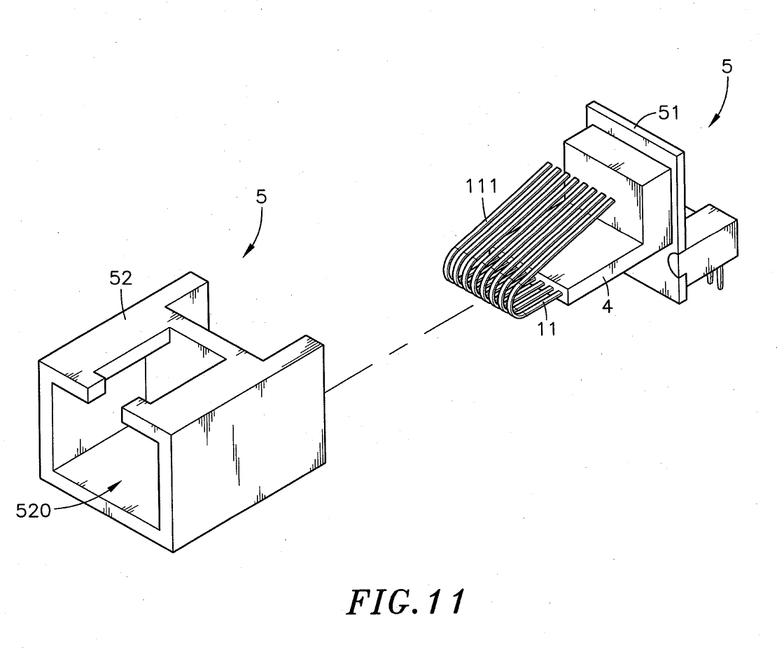

Referring to FIGS. 8-11 and FIG. 1 again, a method for fabricating a conducting terminal set for electrical connector in accordance with a third embodiment of the present invention is shown. This third embodiment is substantially similar to the aforesaid second embodiment with the exception of the following features. According to this third embodiment, prepare two sets of flat elliptical conducting terminals 11 using a cold drawing technique in a similar manner as the aforesaid first and second embodiments, and then prepare two terminal brackets 31;32 using a stamping technique, and then position the two sets of flat elliptical conducting terminals 11 in the clamping grooves 310;320 of the two terminal brackets 31;32, and then locally coat the flat elliptical conducting terminals 11 with a coating, and then insert the two sets of flat elliptical conducting terminals 11 through two vertically spaced and staggered rows of terminal slots 40 of an electrically insulative terminal block 4, and then bend one ends of the flat elliptical conducting terminals 11 at one side of the electrically insulative terminal block 4 backwardly upwards to have the respective ends of the flat elliptical conducting terminals 11 be formed into respective resilient mating end portions 111, and then cut off the other ends of the flat elliptical conducting terminals 11 that protrude over the other side of the electrically insulative terminal block 4 subject to a predetermined length to form respective bonding end portions 112, and then remove the terminal brackets 31;32 from the flat elliptical conducting terminals 11, and then bond the bonding end portions 112 of the flat elliptical conducting terminals 11 to a circuit board 51, and then mount the flat elliptical conducting terminals 11 with the electrically insulative terminal block 4 and the circuit board 51 in an accommodation chamber 520 inside an electrically insulative housing 52 to form an electrical connector 5.

In conclusion, the invention provides a method for fabricating a conducting terminal set for electrical connector, which includes the step of employing a cold drawing technique to repeatedly draw a metal round rod 1 into small round conducting terminal bar or further drawn into a predetermined flat elliptical conducting terminal bar by means of a plurality of cold drawing dies 2 that have a different size of cold drawing hole 20, the step of cutting the flat elliptical conducting terminal bar into multiple pieces of flat elliptical conducting terminals 11 subject to a predetermined length, the step of preparing a terminal bracket 3 having a plurality of clamping grooves 30 using a stamping technique and then positioning the flat elliptical conducting terminals 11 in the clamping grooves 30 of the terminal bracket 3 in a parallel manner, the step of employing a coating technique to locally coat the flat elliptical conducting terminals 11 with a coating, the step of bending respective one ends of the flat elliptical conducting terminals 11 backwardly upwards to have respective ends of the flat elliptical conducting terminal 11 be formed into respective resilient mating end portions 111, the step of inserting the other ends 110 of the flat elliptical conducting terminals 11 through respective terminal slots 40 of an electrically insulative terminal block 4, and the step of cutting off the other ends 110 of the flat elliptical conducting terminals 11 that protrude over the back side of the terminal block 4 to have a predetermined length of the protruding part of the other end 110 of each of the flat elliptical conducting terminals 11 form a respective bonding end portion 112.

As stated above, the invention provides a method for fabricating a conducting terminal set for electrical connector, which has the advantages and features as follows:

1. By means of repeatedly employing a cold drawing technique to drawing a metal round rod into a predetermined flat elliptical conducting terminal bar and then cutting the flat elliptical conducting terminal bar into multiple pieces of flat elliptical conducting terminals, the preparation of the desired flat elliptical conducting terminals avoids material loss, saving conducting terminal manufacturing cost.

2. The flat elliptical conducting terminals are locally coated with a layer of coating after having been positioned in the terminal block, and are bent into the desired shape after coating. Thus, the invention greatly enhances the surface friction force of the conducting terminals, saves the electroplating cost, and improves the signal transmission reliability of the conducting terminal.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A method for fabricating a conducting terminal set for electrical connector, comprising the steps of:
(a) employing a cold drawing technique to draw a metal round rod at least two times to turn the metal round rod into a predetermined flat elliptical conducting terminal bar;
(b) cutting said flat elliptical conducting terminal bar into multiple pieces of flat elliptical conducting terminals subject to a predetermined length;
(c) preparing a terminal bracket having a plurality of clamping grooves using a stamping technique and then positioning a predetermined number of said flat elliptical conducting terminals in the clamping grooves of said terminal bracket in a parallel manner;
(d) employing a coating technique to locally coat said flat elliptical conducting terminals with a coating; and
(e) bending respective one ends of said flat elliptical conducting terminals at one side of said terminal bracket to have respective ends of said flat elliptical conducting terminal be formed into respective resilient mating end portions.

2. The method for fabricating a conducting terminal set for electrical connector as claimed in claim 1, wherein in step (a), the metal round rod is drawn by means of a plurality of cold drawing dies that have a different size of cold drawing hole, and the size of the metal round rod is reduced after each drawing, and the predetermined flat elliptical conducting terminal bar thus obtained has two opposing flat surfaces and two opposing smoothly curved edges.

3. The method for fabricating a conducting terminal set for electrical connector as claimed in claim 1, wherein step (e) is to bend respective one ends of said flat elliptical conducting terminals at one side of said terminal bracket backwardly upwards to have respective ends of said flat elliptical conducting terminal be formed into respective resilient mating end portions that are elastically deformable.

4. The method for fabricating a conducting terminal set for electrical connector as claimed in claim 1, wherein step (d) is to employ one of the coating techniques of electroplating, brushing plating to coat one side or both sides of said flat elliptical conducting terminals and hot-dip plating to coat a predetermined section of said flat elliptical conducting terminals.

5. The method for fabricating a conducting terminal set for electrical connector as claimed in claim 1, further comprising the steps of:
(f) inserting respective opposite ends of said flat elliptical conducting terminals at an opposite side of said terminal bracket through respective terminal slots of an electrically insulative terminal block; and
(g) cutting off the respective opposite ends of said flat elliptical conducting terminals that protrude over a back side of said terminal bracket to have a predetermined length of the protruding part of the respective opposite ends of said flat elliptical conducting terminals to form respective bonding end portions.

6. A method for fabricating a conducting terminal set for electrical connector, comprising the steps of:
(a) employing a cold drawing technique to draw a metal round rod at least two times to turn the metal round rod into a predetermined round conducting terminal bar;
(b) cutting said round conducting terminal bar into multiple pieces of round conducting terminals subject to a predetermined length;
(c) preparing a terminal bracket using a stamping technique, each said terminal bracket having a plurality of clamping grooves, and then positioning a predetermined number of said round conducting terminals in the clamping grooves of said terminal bracket in a parallel manner;
(d) employing a coating technique to locally coat said round conducting terminals with a coating; and
(e) inserting respective one ends of said two sets of said round conducting terminals through respective terminal slots of an electrically insulative terminal block and then bending the respective one ends of said round conducting terminals to form respective mating end portions.

7. The method for fabricating a conducting terminal set for electrical connector as claimed in claim 6, wherein in step (a), the metal round rod is drawn by means of a plurality of cold drawing dies that have a different size of cold drawing hole, and the size of the metal round rod is reduced after each cold drawing, and the round conducting terminal bar is finally obtained.

8. The method for fabricating a conducting terminal set for electrical connector as claimed in claim 6, wherein step (e) is to bend respective one ends of said round conducting terminals at one side of said terminal block backwardly upwards to have respective one ends of said round conducting terminals be formed into respective resilient mating end portions that are elastically deformable.

9. The method for fabricating a conducting terminal set for electrical connector as claimed in claim 6, wherein step (d) is to employ one of the coating techniques of electroplating, brushing plating to coat one side or both sides of said round conducting terminals and hot-dip plating to coat a predetermined section of said round conducting terminals.

10. The method for fabricating a conducting terminal set for electrical connector as claimed in claim 6, further comprising a step of (f) cutting off respective opposite ends of said round conducting terminals subject to said predetermined length to have the respective opposite ends of said round conducting terminals to form respective bonding end portions and removing said terminal bracket from said round conducting terminals.
